(19) United States
(12) Patent Application Publication
(10) Pub. No.: US 2025/0117092 A1
(43) Pub. Date: Apr. 10, 2025

(54) GESTURE SENSOR USING RADIO-FREQUENCY SIGNALS

(71) Applicants: Georgios C. TRICHOPOULOS, Tempe, AZ (US); Bharath G. KASHYAP, Tempe, AZ (US)

(72) Inventors: Georgios C. TRICHOPOULOS, Tempe, AZ (US); Bharath G. KASHYAP, Tempe, AZ (US)

(21) Appl. No.: 18/906,157

(22) Filed: Oct. 3, 2024

Related U.S. Application Data
(60) Provisional application No. 63/587,998, filed on Oct. 4, 2023.

(51) Int. Cl. G06F 3/01; G01S 7/02; G01S 13/06; H01P 5/12; H01Q 1/22; H01Q 13/20

(52) U.S. Cl. CPC G06F 3/017; G01S 7/027; G01S 13/06; H01P 5/12; H01Q 1/2283; H01Q 13/206

(57) ABSTRACT

A system and method for gesture sensor using radio-frequency signals. In some embodiments, a system includes a band configured to fit on the wrist of a user. The band may include a first electromagnetic coupling circuit having a first feed port, the first electromagnetic coupling circuit being configured to: receive a first drive signal at the first feed port, couple the first drive signal to tissues of the wrist, receive a first reflected signal from the tissues of the wrist, and couple the first reflected signal to the first feed port.

### CROSS-REFERENCE TO RELATED APPLICATION(S)

The present application claims priority to and the benefit of U.S. Provisional Application No. 63/587,998, filed Oct. 4, 2023, entitled “GESTURE SENSOR USING RADIO-FREQUENCY SIGNALS”, the entire content of which is incorporated herein by reference.

### FIELD

One or more aspects of embodiments according to the present disclosure relate to gesture sensing, and more particularly to sensing of hand gestures using radio-frequency signals.

### BACKGROUND

Hand gestures may be an effective and natural way for a user to communicate with a machine, e.g., with a computer.

It is with respect to this general technical environment that aspects of the present disclosure are related.

### SUMMARY

According to an embodiment of the present disclosure, there is provided a system, including: a band configured to fit on the wrist of a user, the band including a first electromagnetic coupling circuit having a first feed port, the first electromagnetic coupling circuit being configured to: receive a first drive signal at the first feed port, couple the first drive signal to tissues of the wrist, receive a first reflected signal from the tissues of the wrist, and couple the first reflected signal to the first feed port.

In some embodiments, the first electromagnetic coupling circuit includes a leaky-wave antenna.

In some embodiments, the first electromagnetic coupling circuit includes a substrate integrated waveguide including the leaky-wave antenna.

In some embodiments, the substrate integrated waveguide includes a slot parallel to, and offset from a centerline between, two rows of ground vias, the slot having a length at least one half the length of the substrate integrated waveguide.

In some embodiments, the substrate integrated waveguide includes: a first slot; and a second slot, the first slot being parallel to two rows of ground vias, and offset on a first side of a centerline between the two rows of ground vias, the first slot having a length of at most one quarter the length of the substrate integrated waveguide; and the second slot being parallel to the two rows of ground vias, and offset on a second side, opposite the first side, of the centerline, the second slot having a length of at most one quarter the length of the substrate integrated waveguide.

In some embodiments, the substrate integrated waveguide is on a flexible substrate having a thickness of less than 2 mm.

In some embodiments, the substrate integrated waveguide has a cutoff frequency of less than 14 gigahertz.

In some embodiments, the system further includes a processing circuit, the processing circuit being configured to estimate, based on the first reflected signal, an aspect of a hand position of the user.

In some embodiments, the system includes a machine learning model implemented in the processing circuit, the machine learning model being configured to estimate, based on the first reflected signal, the aspect of the hand position of the user.

In some embodiments, the band further includes a second electromagnetic coupling circuit having a second feed port, the second electromagnetic coupling circuit being configured to: receive a second drive signal at the second feed port, couple the second drive signal to tissues of the wrist, receive a second reflected signal from the tissues of the wrist, and couple the second reflected signal to the second feed port.

In some embodiments, the second electromagnetic coupling circuit includes a microstrip transmission line.

In some embodiments, the band further includes a third electromagnetic coupling circuit having a third feed port, the third electromagnetic coupling circuit being configured to: receive a third drive signal at the third feed port, couple the third drive signal to tissues of the wrist, receive a third reflected signal from the tissues of the wrist, and couple the third reflected signal to the third feed port, wherein the third electromagnetic coupling circuit includes a microstrip transmission line.

In some embodiments, the system further includes a processing circuit, the processing circuit being configured to estimate, based on the first reflected signal, an aspect of a hand position of the user in the presence of an air gap between the band and the wrist.

In some embodiments, the system includes a machine learning model implemented in the processing circuit, the machine learning model being configured to estimate, based on the first reflected signal, the aspect of the hand position of the user in the presence of the air gap.

In some embodiments, the first electromagnetic coupling circuit includes: a slot; and one or more diodes connected across the slot.

In some embodiments, the diodes are pin diodes.

In some embodiments, the system further includes a processing circuit, the processing circuit being configured: to estimate, based on the first reflected signal, a rotational shift of the band, and to adjust one or more respective biases of the one or more diodes so as to adjust an effective position of the slot to compensate for the rotational shift.

In some embodiments, the estimating includes estimating based on signal characteristics affected by time-varying characteristics of arteries in the wrist.

According to an embodiment of the present disclosure, there is provided a method including: coupling, by an electromagnetic coupling circuit in a band configured to fit on the wrist of a user, a first drive signal to tissues of the wrist; and receiving a first reflected signal from the tissues of the wrist.

In some embodiments, the electromagnetic coupling circuit includes a substrate integrated waveguide including a leaky-wave antenna.

### BRIEF DESCRIPTION OF THE DRAWINGS

These and other features and advantages of the present disclosure will be appreciated and understood with reference to the specification, claims, and appended drawings wherein:

FIG. 1A is a block diagram of a system for gesture sensing, according to an embodiment of the present disclosure;

FIG. 1B is a schematic perspective cutaway view of a user's wrist and a sensing band, according to an embodiment of the present disclosure;

FIG. 1C is a table of tissue characteristics, according to an embodiment of the present disclosure;

FIG. 1D is a table of design parameters, according to an embodiment of the present disclosure;

FIG. 2A is a top view of a sensing band, according to an embodiment of the present disclosure;

FIG. 2B is a bottom view of a sensing band, according to an embodiment of the present disclosure;

FIG. 2C is a top view of a sensing band, according to an embodiment of the present disclosure;

FIG. 2D is a bottom view of a sensing band, according to an embodiment of the present disclosure;

FIG. 3A is a graph of reflection coefficients, according to an embodiment of the present disclosure;

FIG. 3B is a graph of reflection coefficients, according to an embodiment of the present disclosure;

FIG. 4 is a perspective view of a sensing band, according to an embodiment of the present disclosure;

FIG. 5 is a cross-sectional view of a wrist and a sensing band, according to an embodiment of the present disclosure;

FIG. 6A is a cross-sectional view of a wrist and a sensing band, according to an embodiment of the present disclosure;

FIG. 6B is a top view of two sensing bands, according to two respective embodiments of the present disclosure;

FIG. 6C is a top view of a sensing band, according to an embodiment of the present disclosure;

FIG. 6D is a cross-sectional view of a wrist and a sensing band, according to an embodiment of the present disclosure; and

FIG. 7 is a schematic drawing of a system for training a machine learning model, according to an embodiment of the present disclosure.

### DETAILED DESCRIPTION

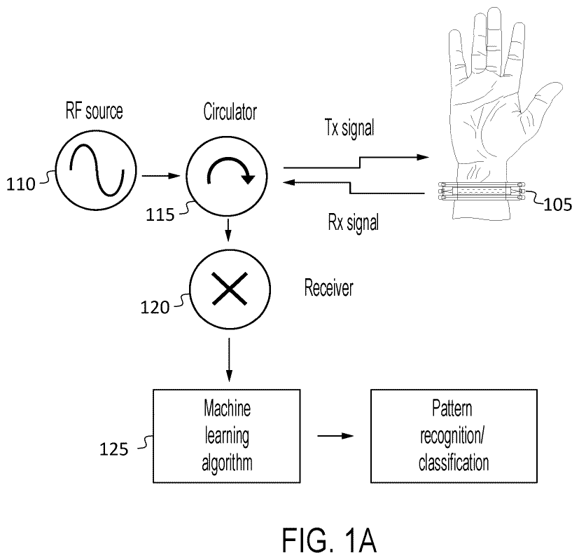

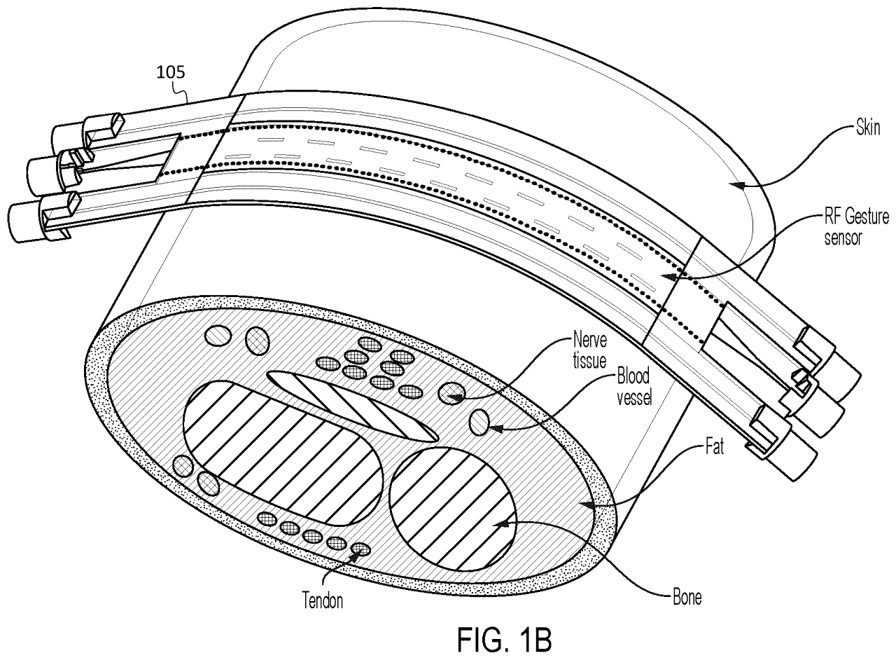

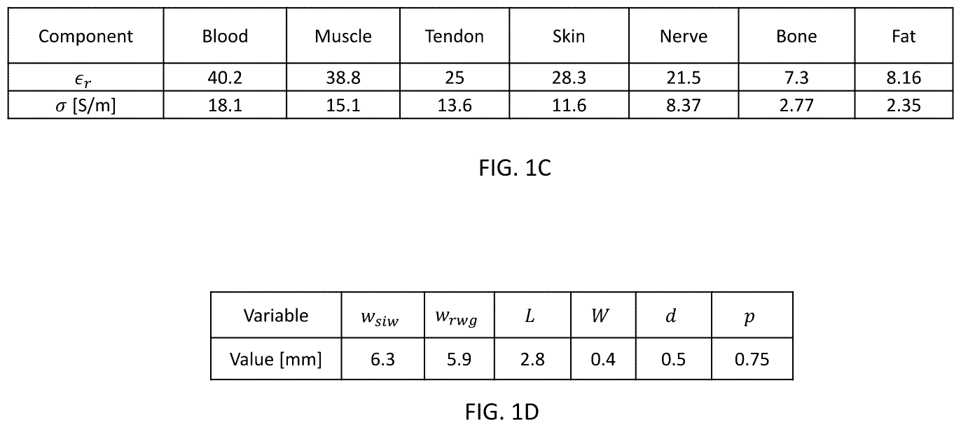

The detailed description set forth below in connection with the appended drawings is intended as a description of exemplary embodiments of a gesture sensor provided in accordance with the present disclosure and is not intended to represent the only forms in which the present disclosure may be constructed or utilized. The description sets forth the features of the present disclosure in connection with the illustrated embodiments. It is to be understood, however, that the same or equivalent functions and structures may be accomplished by different embodiments that are also intended to be encompassed within the scope of the disclosure. As denoted elsewhere herein, like element numbers are intended to indicate like elements or features. Each of FIGS. 1B, 2A-2D, and 4-6D is drawn to scale for a respective embodiment.

Hand gestures have been integral parts of non-verbal communication throughout human history to elegantly convey information with little effort. As such, it may be advantageous to adopt this mode of information delivery to interact with machines. Specifically, different hand motions may be associated with gestures that can be interpreted by a computer as commands to carry out specific tasks. Such gesture-based human-computer interaction (HCl) systems may have applications, for example, in the fields of virtual or augmented reality, robotics, sign language detection, prosthetics and rehabilitation, and gaming.

Gesture sensing techniques may be based on electromyography (EMG), infrared (IR) sensors, camera-based sensors, radars, ultrasound, or the like. These techniques may be capable of faithfully capturing motion-specific information, but an additional block may be needed to associate the obtained data to individual gestures; this may be achieved through machine learning algorithms. Thus, a gesture sensor using such techniques may consist primarily of two elements—a signal detection block and a classification block. With an increase in the number of wearable electronics, wearable gesture sensors (e.g., sensors that may be integrated into wearable devices) may have increased utility. Camera-based and ultrasound sensors may be bulky; some radar, EMG, and IR sensors may be miniaturized sufficiently to be embedded into consumer electronics like smartwatches and wristbands.

Some embodiments include a leaky-wave antenna (LWA) design that works on near-field monostatic radar principles to detect the changes in the electric field caused by various motions of the hand. Such a design may solve some of the shortcomings of other gesture sensors, such as sensitivity to skin color, to rapid hand movements, and to environmental interference. The leaky-wave antenna (LWA) design may be integrated with machine learning algorithms for efficient and automated gesture sensing.

In some embodiments, a substrate integrated waveguide (SIW) LWA is employed as the electromagnetic coupling structure (e.g., as the radiating element) to couple the electromagnetic energy into the human wrist. The operating principle of the gesture sensor is shown in FIG. 1A. The sensing band 105, which may include a SIW-LWA is excited by a continuous wave (CW) radiofrequency (RF) source 110 (which may be a swept frequency source) through a subminiature push on (SMP) connector at an input, or “feed port” of the band. In some embodiments, the RF source is integrated (soldered) on to the same substrate as the SIW-LWA, and the RF source is connected (e.g., through a circulator 115 or through a 4-port hybrid coupler) to the feed port, without an intervening connector. The RF signals propagate along the SIW and leak into the wrist tissues through the slots along the SIW. The reflected signals from different components within the wrist (tendons, blood vessels, nerves, muscles, bones, etc.) are recorded using a coupler (or using the circulator 115) and an RF receiver 120. When a user performs various gestures, the hand and finger motions change the relative positions of the tissues within the wrist, thus providing unique information corresponding to each gesture. This information is then post-processed (e.g., by a machine learning algorithm 125 trained to perform pattern recognition or classification) to identify and classify different gestures. A simplified 3D model of the human wrist with representative tissues may be used to carry out simulations of the gesture sensor. The cross-section of the human wrist with the sensor mounted on the anterior side is shown in FIG. 1B.

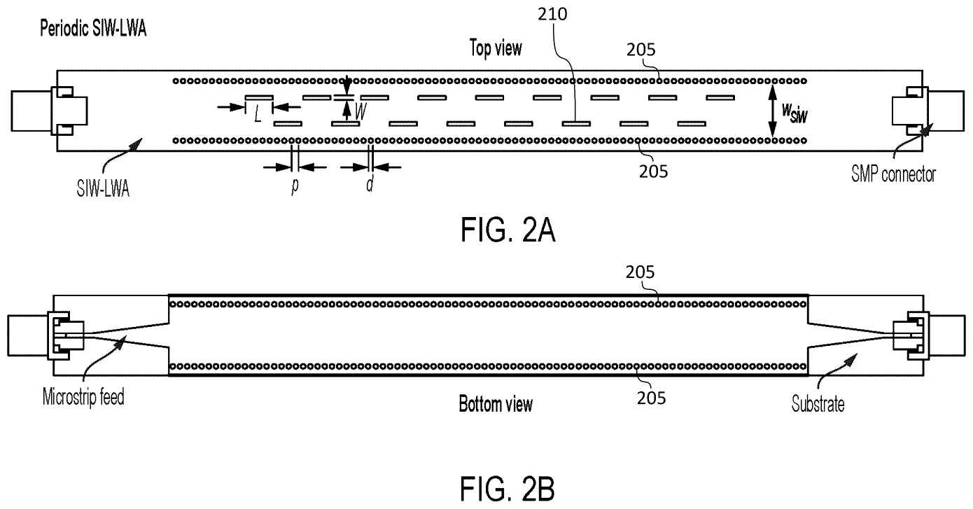

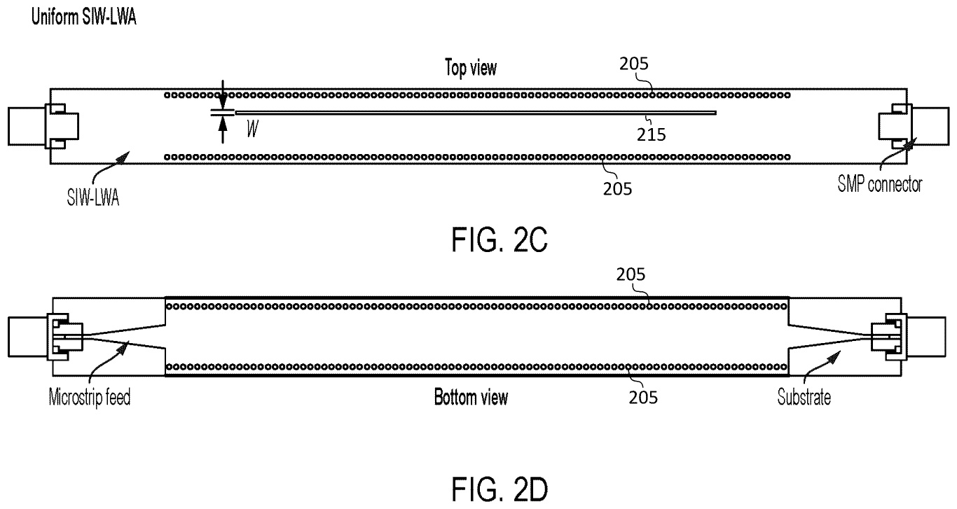

FIGS. 2A and 2B show a top view and a bottom view of the band 105, in a first embodiment, and FIGS. 2C and 2D show a top view and a bottom view of the band 105 in a second embodiment. Each of FIGS. 2A-2D shows the sensing band 105 in a flattened shape that it may have when not worn on the wrist of a user. The substrate integrated waveguide has lateral edges defined by two parallel rows of ground vias 205. The radiating surface (which is shown in the top view of FIG. 2A, and which faces the wrist of the user when the band is worn) has two rows of slots 210 offset on opposite sides of a centerline between the two rows of ground vias 205. In the second embodiment (FIGS. 2C and 2D), the substrate integrated waveguide instead has a single long slot 215 offset on one side of the centerline (see, e.g., FIG. 2C). The SIW may be designed in a substrate suitable to be curved and mounted on the wrist, with the proper fixture support (e.g., in a 0.508 mm thick flexible Rogers R03010 substrate (ϵᵣ_{_{sub}}=10.2, tan δ=0.0022), or in another material with similar properties). The thickness of the substrate may be selected in part based on the operating frequency range, and may be greater or less than 0.508 mm. The SIW may be designed to operate in the dominant TE₁₀ mode with a cut-off frequency of 9 gigahertz (GHz). The width of the SIW, w_{siw}, is obtained using

$${w}_{siw} = {w}_{rwg} + \frac{{d}^{2}}{0.95 p} \qquad ( 1 )$$

where d is the diameter of the vias, p is the spacing between the vias, and w_{rwg} is the width of the corresponding rectangular waveguide, which determines the cut-off frequency, f_{c_10} according to

$${f}_{c \_ 10} = \frac{c}{2 π {w}_{rwg} \sqrt{{ϵ}_{r \_ sub}}} \qquad ( 2 )$$

The LWA may be designed as an array of slots with length, L=˜λ₀/2 and width, W=˜λ₀/20, where λ₀ is the wavelength in the radiation medium (e.g., the wrist). The slots are uniformly distributed with a spacing of λ_{g}/2, where λ₉ is the wavelength within the substrate. The tissues in the wrist have a wide range of variations in their relative permittivities (52 to 5) as listed in the table of FIG. 1C, which shows dielectric constants of the wrist anatomy. As such, an average δ_{r_medium}=25 may be chosen to design the LWA slots. The design parameters of the SIW-LWA are listed in the table of FIG. 1D (which shows gesture sensor design parameters), for some embodiments. To facilitate real-world measurements using a prototype sensor, a λ_{g}/2 long tapered matching network is designed to transition from the SIW to 50Ω microstrip line.

The LWA may operate in the 9 GHz-14 GHz frequency band (or in a smaller frequency band, or in a (smaller or larger) frequency band extending to frequencies lower than 9 GHz or to frequencies higher than 14 GHz) and focuses on different parts of the wrist as the frequency is scanned. The operation in this frequency range provides suitable miniaturization for wearables and good resolution while also achieving sufficient penetration depth within the wrist. As the electromagnetic signal propagates into the wrist, a part of it is absorbed, while the remaining portion of the signal undergoes multiple reflections from different tissues within the wrist. Thus, the backscattered signal contains information corresponding to different tissues and their positions for each gesture. The SIW-LWA exhibits a very high positional accuracy. Consequently, micro-variations in the locations of the wrist tissues, of the order of 0.1 mm, can be recorded. This information can then be post-processed to classify the gestures. Further, the band may include one or more SIW to microstrip transitions designed to enable coupling to the SIW (e.g., through connectors and microstrip transmission lines). The transition is optimized to ensure a good match is obtained between the microstrip and SIW sections. Such a transition however, may still result in some spurious radiation which can couple into the skin and alter the performance of the sensor. As such, the microstrip feed is designed to be on the bottom layer of the sensor (the layer facing away from the skin of the wrist) so that any spurious radiation is directed away from the wrist. Additionally, since a SIW-LWA geometry is employed, the sensor is not susceptible to back radiation from the SIW section. Other types of feeding topologies may be also used including coplanar-waveguide to SIW transitions or coaxial probe to SIW transitions.

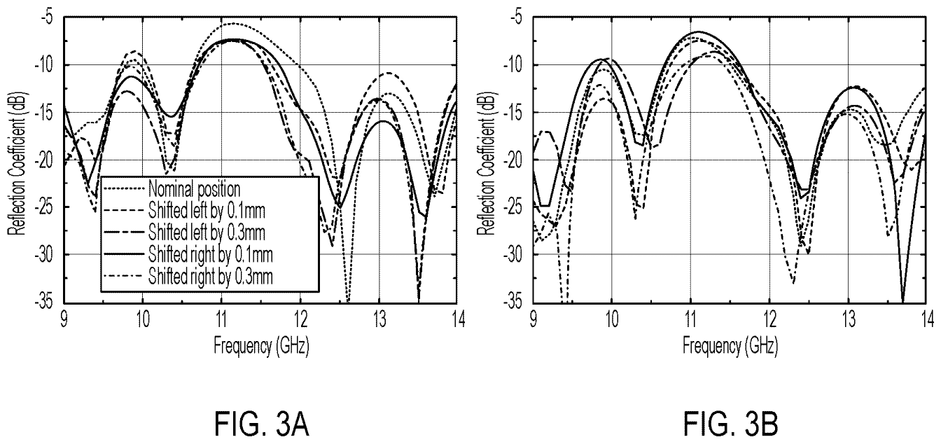

The gesture sensor was designed in Ansys HFSS and arranged as shown in FIG. 1B to carry out simulations. Such simulations may be used to verify the sensitivity of the sensor to various micro-motions of the wrist tissues. Two tendons—one closest to the skin surface and a second buried among other tissues within the wrist—were chosen for the sensitivity analysis of the sensor. A parametric simulation was carried out for 5 different positions of each of the two tendons (nominal, shifted left by 0.1 and 0.3 mm, and shifted right by 0.1 and 0.3 mm). The resulting reflection coefficient (S₁₁) plots obtained from the sensor are shown in FIGS. 3A and 3B, which show reflection coefficient plots showing the sensitivity of the gesture sensor to micro-variations of tendon positions. The tendons are moved from their nominal position to the left and right by 0.1 mm and 0.3 mm. FIG. 3A shows a case in which a tendon close to the skin surface is moved, and FIG. 3B shows a case in which a buried tendon closer to the bone is moved. The sensor can successfully radiate into the lossy wrist medium to a sufficient depth and capture minor variations in the positions of both tendons.

In some embodiments, an RF gesture sensor can efficiently capture the positional variations of various tissues in the human hand resulting from different gestures. The information obtained from the reflected signals is unique to each gesture and thus can be used to identify and classify various gestures.

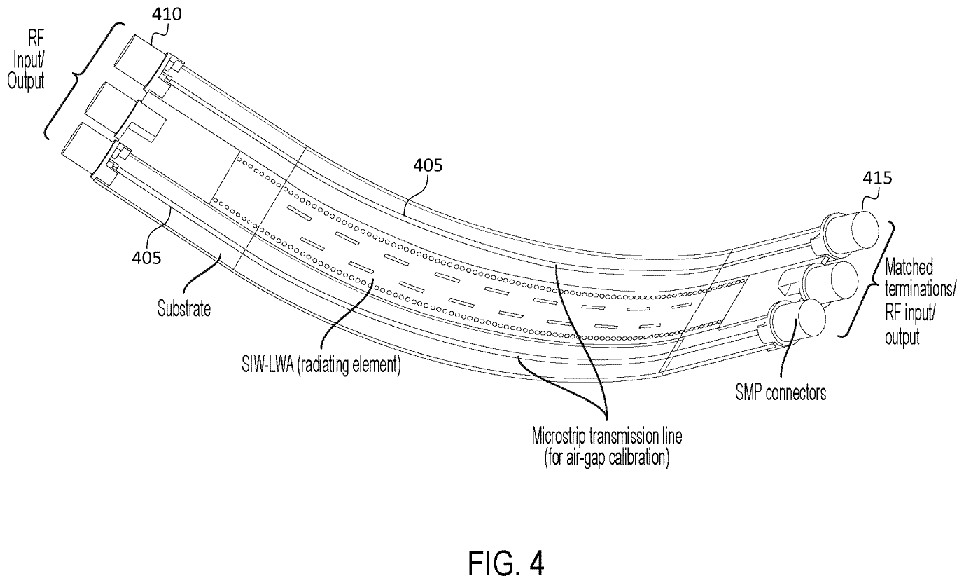

FIG. 4 is a perspective view of the band, in an embodiment including both a substrate integrated waveguide and two microstrip waveguides 405 (e.g., microstrip transmission lines). Input/output connections may be made by RF connectors 410 at one end of the substrate integrated waveguide and of the two microstrip waveguides, and the other end of each of the waveguides may be terminated by a suitable resistive termination 415, or an input or output connection may be present at the other end of one or more of the waveguides (in such an embodiment S21 may be used for gesture classification). In some embodiments the ends of the waveguides are terminated, instead of by SMP connectors, by coaxial cables (connected to a transceiver) at the feed ends of the waveguides, and by termination resistors installed on (e.g., soldered to) the substrate at the other ends.

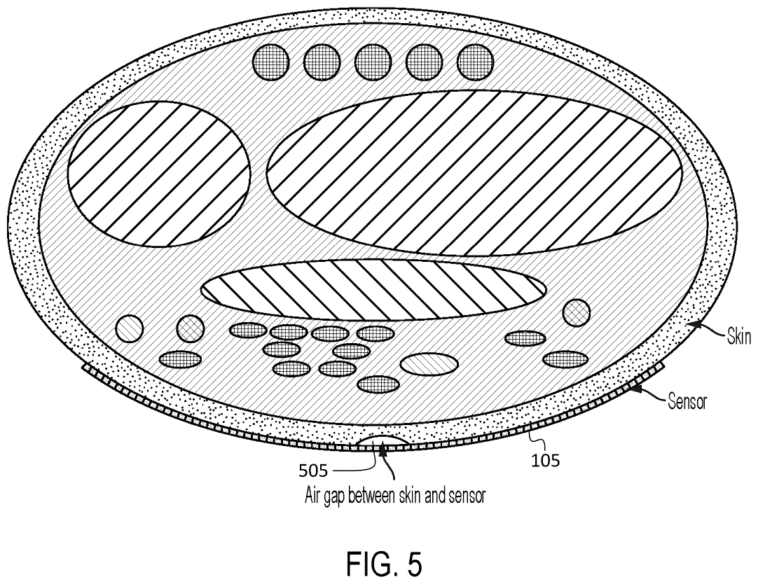

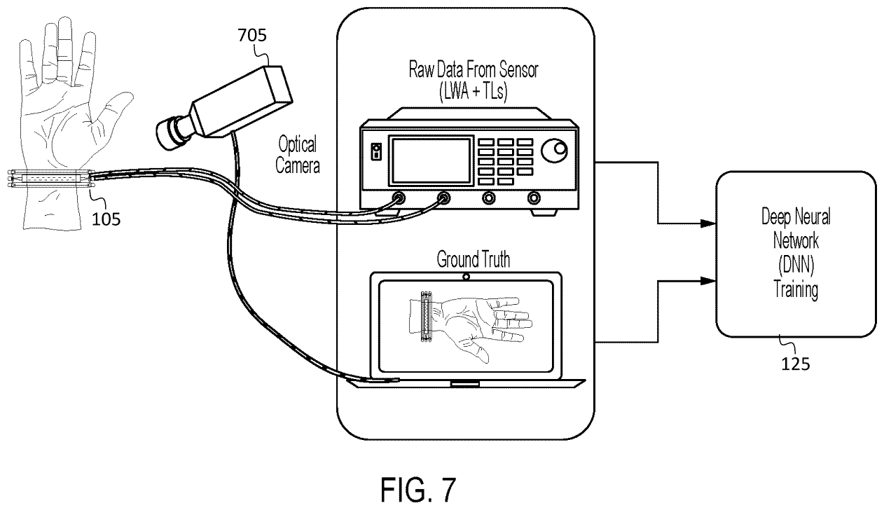

FIG. 5 shows an air gap 505 between the wrist and the band, which may affect the measurements made with the substrate integrated waveguide leaky-wave antenna. Each microstrip transmission line may be more sensitive to the presence of an air gap (which may affect the characteristic impedance at the air gap, causing a reflection) than to changes in the internal structure of the wrist (with which the microstrip transmission lines may interact relatively little). As such, the microstrip transmission lines on either side of the SIW-LWA as shown in FIG. 4 may be employed to sense, and compensate for, any air gaps that may be present. A machine learning model may be employed to make such corrections as discussed in the context of FIG. 7.

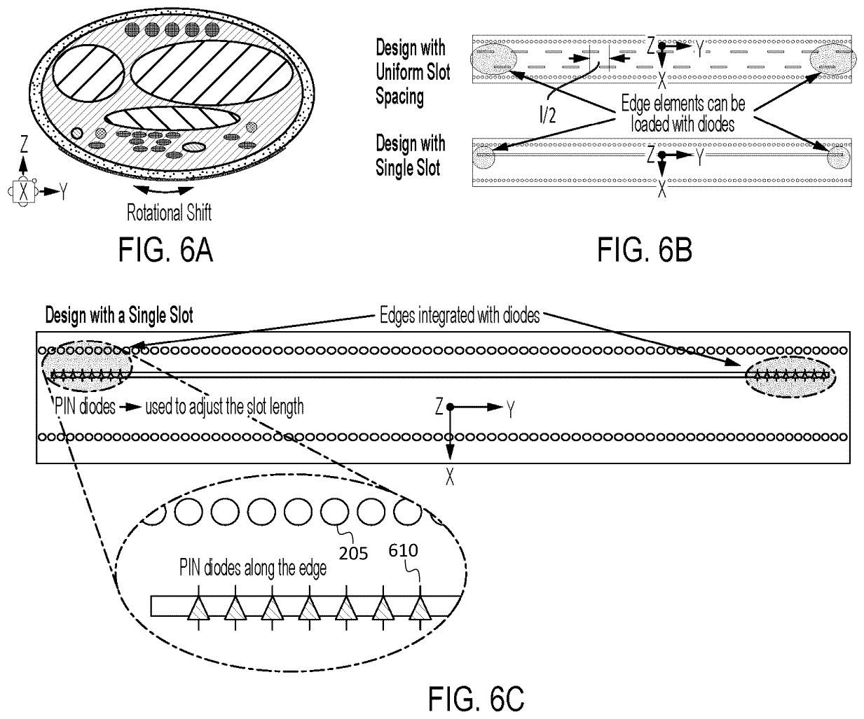

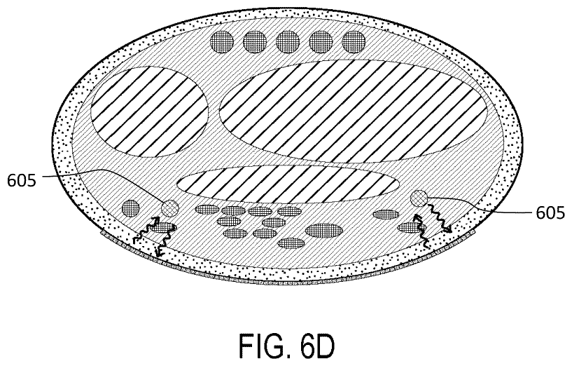

As shown in FIG. 6A, the band may be able, while worn, to shift in rotation about the longitudinal axis of the user's forearm. Such a rotational shift may be measured, as illustrated in FIG. 6D, by determining the position of the radiating elements (e.g., the slots) relative to arteries 605 in the wrist (e.g., relative to the radial and ulnar arteries), which may, because of the fluctuation of their respective diameters with the pulse of the user, produce signals readily distinguishable, if obtained over some interval of time, from signals due to structures in the wrist that do not exhibit a periodic change synchronized with the user's pulse. Once the rotational shift has been measured with respect to these arteries, it may be compensated for by adjusting the effective position of the radiating slot or slots by changing the bias on one or more diodes 610 connected across the slot or slots as shown in FIGS. 6B and 6C. For example, one or more pin diodes (or other RF switches) at the end of a slot may be turned on, using a forward bias, to move the effective end of the slot. In a design with an array of slots, both ends of each slot may be effectively moved in this manner so as to move the effective position of the array of slots.

Referring to FIG. 7, a machine learning model 125 may be used to estimate an aspect of a hand position of the user. For example, the hand position may be modeled as a set of angles formed, between the bones, at the joints of the user's hand, or by a set of triangles approximating the surface of the user's hand. Any information that may be used in the construction of such a model (e.g., an estimate of the extent to which one of the fingers is bent) may be an aspect of a hand position of the user.

During training, the machine learning model may be configured to receive two inputs, a first input being an electrical characterization of the band 105 (e.g., S₁₁, the (1,1) S-parameter, as a function of frequency, of each of the waveguides in the band); each such electrical characterization may be referred to as a “spectrum” for the hand position for which it is obtained. Each spectrum may be obtained during an interval that may be significantly shorter (e.g., each frequency sweep may be significantly shorter) than the period of the pulse of the user. The second input may be an independent sensor of hand position (e.g., a camera 705). Supervised training of the machine learning model may be performed by having the user move the hand to various different positions and using the second input to label each spectrum with the hand position for which it was obtained. To generate a machine learning model that is capable of performing reliable classifications in the presence of air gaps and rotational offsets, such air gaps and rotational offsets may be intentionally introduced into some of the training data.

In some embodiments, an electromagnetic coupling structure different from the substrate integrated waveguide leaky-wave antennas illustrated in FIGS. 4 and 6D may be used. For example, the coupling structure may be a microstrip waveguide with sections (e.g., quarter-wave sections) of different characteristic impedance, or a conductive loop operating as a loop antenna, or an array of conductive loops. In some embodiments, the electromagnetic coupling structure is or includes a phased array of radiating elements, independently driven by multiple feed ports at the end or ends of the band, or by active circuits integrated into the band.

As used herein, “a portion of” something means “at least some of” the thing, and as such may mean less than all of, or all of, the thing. As such, “a portion of” a thing includes the entire thing as a special case, i.e., the entire thing is an example of a portion of the thing. As used herein, the word “or” is inclusive, so that, for example, “A or B” means any one of (i) A, (ii) B, and (iii) A and B.

Each of the terms “processing circuit” and “means for processing” is used herein to mean any combination of hardware, firmware, and software, employed to process data or digital signals. Processing circuit hardware may include, for example, application specific integrated circuits (ASICs), general purpose or special purpose central processing units (CPUs), digital signal processors (DSPs), graphics processing units (GPUs), and programmable logic devices such as field programmable gate arrays (FPGAs). In a processing circuit, as used herein, each function is performed either by hardware configured, i.e., hard-wired, to perform that function, or by more general-purpose hardware, such as a CPU, configured to execute instructions stored in a non-transitory storage medium. A processing circuit may be fabricated on a single printed circuit board (PCB) or distributed over several interconnected PCBs. A processing circuit may contain other processing circuits; for example, a processing circuit may include two processing circuits, an FPGA and a CPU, interconnected on a PCB.

As used herein, when a method (e.g., an adjustment) or a first quantity (e.g., a first variable) is referred to as being “based on” a second quantity (e.g., a second variable) it means that the second quantity is an input to the method or influences the first quantity, e.g., the second quantity may be an input (e.g., the only input, or one of several inputs) to a function that calculates the first quantity, or the first quantity may be equal to the second quantity, or the first quantity may be the same as (e.g., stored at the same location or locations in memory as) the second quantity.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed herein could be termed a second element, component, region, layer or section, without departing from the spirit and scope of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that such spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the inventive concept. As used herein, the terms “substantially,” “about,” and similar terms are used as terms of approximation and not as terms of degree, and are intended to account for the inherent deviations in measured or calculated values that would be recognized by those of ordinary skill in the art.

As used herein, the singular forms “a” and “an” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Further, the use of “may” when describing embodiments of the inventive concept refers to “one or more embodiments of the present disclosure”. Also, the term “exemplary” is intended to refer to an example or illustration. As used herein, the terms “use,” “using,” and “used” may be considered synonymous with the terms “utilize,” “utilizing,” and “utilized,” respectively.

It will be understood that when an element or layer is referred to as being “on”, “connected to”, “coupled to”, or “adjacent to” another element or layer, it may be directly on, connected to, coupled to, or adjacent to the other element or layer, or one or more intervening elements or layers may be present. In contrast, when an element or layer is referred to as being “directly on”, “directly connected to”, “directly coupled to”, or “immediately adjacent to” another element or layer, there are no intervening elements or layers present.

Any numerical range recited herein is intended to include all sub-ranges of the same numerical precision subsumed within the recited range. For example, a range of “1.0 to 10.0” or “between 1.0 and 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Similarly, a range described as “within 35% of 10” is intended to include all subranges between (and including) the recited minimum value of 6.5 (i.e., (1-35/100) times 10) and the recited maximum value of 13.5 (i.e., (1+35/100) times 10), that is, having a minimum value equal to or greater than 6.5 and a maximum value equal to or less than 13.5, such as, for example, 7.4 to 10.6. Any maximum numerical limitation recited herein is intended to include all lower numerical limitations subsumed therein and any minimum numerical limitation recited in this specification is intended to include all higher numerical limitations subsumed therein.

Although exemplary embodiments of a gesture sensor have been specifically described and illustrated herein, many modifications and variations will be apparent to those skilled in the art. Accordingly, it is to be understood that a gesture sensor constructed according to principles of this disclosure may be embodied other than as specifically described herein. The invention is also defined in the following claims, and equivalents thereof.

What is claimed is:

1. A system, comprising:
a band configured to fit on the wrist of a user,
the band comprising a first electromagnetic coupling circuit having a first feed port,
the first electromagnetic coupling circuit being configured to:
receive a first drive signal at the first feed port,
couple the first drive signal to tissues of the wrist,
receive a first reflected signal from the tissues of the wrist, and
couple the first reflected signal to the first feed port.

2. The system of claim 1, wherein the first electromagnetic coupling circuit comprises a leaky-wave antenna.

3. The system of claim 2, wherein the first electromagnetic coupling circuit comprises a substrate integrated waveguide comprising the leaky-wave antenna.

4. The system of claim 3, wherein the substrate integrated waveguide comprises a slot parallel to, and offset from a centerline between, two rows of ground vias, the slot having a length at least one half the length of the substrate integrated waveguide.

5. The system of claim 3, wherein the substrate integrated waveguide comprises:
a first slot; and
a second slot,
the first slot being parallel to two rows of ground vias, and offset on a first side of a centerline between the two rows of ground vias, the first slot having a length of at most one quarter the length of the substrate integrated waveguide; and
the second slot being parallel to the two rows of ground vias, and offset on a second side, opposite the first side, of the centerline, the second slot having a length of at most one quarter the length of the substrate integrated waveguide.

6. The system of claim 3, wherein the substrate integrated waveguide is on a flexible substrate having a thickness of less than 2 mm.

7. The system of claim 3, wherein the substrate integrated waveguide has a cutoff frequency of less than 14 gigahertz.

8. The system of claim 1, further comprising a processing circuit, the processing circuit being configured to estimate, based on the first reflected signal, an aspect of a hand position of the user.

9. The system of claim 8, comprising a machine learning model implemented in the processing circuit, the machine learning model being configured to estimate, based on the first reflected signal, the aspect of the hand position of the user.

10. The system of claim 1, wherein the band further comprises a second electromagnetic coupling circuit having a second feed port, the second electromagnetic coupling circuit being configured to:
receive a second drive signal at the second feed port,
couple the second drive signal to tissues of the wrist,
receive a second reflected signal from the tissues of the wrist, and
couple the second reflected signal to the second feed port.

11. The system of claim 10, wherein the second electromagnetic coupling circuit comprises a microstrip transmission line.

12. The system of claim 1, wherein the band further comprises a third electromagnetic coupling circuit having a third feed port, the third electromagnetic coupling circuit being configured to:
receive a third drive signal at the third feed port,
couple the third drive signal to tissues of the wrist,
receive a third reflected signal from the tissues of the wrist, and
couple the third reflected signal to the third feed port,
wherein the third electromagnetic coupling circuit comprises a microstrip transmission line.

13. The system of claim 10 further comprising a processing circuit, the processing circuit being configured to estimate, based on the first reflected signal, an aspect of a hand position of the user in the presence of an air gap between the band and the wrist.

14. The system of claim 13, comprising a machine learning model implemented in the processing circuit, the machine learning model being configured to estimate, based on the first reflected signal, the aspect of the hand position of the user in the presence of the air gap.

15. The system of claim 1, wherein the first electromagnetic coupling circuit comprises:
a slot; and
one or more diodes connected across the slot.

16. The system of claim 15, wherein the diodes are pin diodes.

17. The system of claim 15, further comprising a processing circuit, the processing circuit being configured:
to estimate, based on the first reflected signal, a rotational shift of the band, and
to adjust one or more respective biases of the one or more diodes so as to adjust an effective position of the slot to compensate for the rotational shift.

18. The system of claim 17 wherein the estimating comprises estimating based on signal characteristics affected by time-varying characteristics of arteries in the wrist.

19. A method comprising:
coupling, by an electromagnetic coupling circuit in a band configured to fit on the wrist of a user, a first drive signal to tissues of the wrist; and
receiving a first reflected signal from the tissues of the wrist.

20. The method of claim 19, wherein the electromagnetic coupling circuit comprises a substrate integrated waveguide comprising a leaky-wave antenna.
